(19) United States
(12) Patent Application Publication
(10) Pub. No.: US 2008/0284559 A1
(43) Pub. Date: Nov. 20, 2008

(54) Device for Controlling an Air Conducting Element in a Motor Vehicle

(75) Inventors: Peter Biber, Regensburg (DE); Stephan Heinrich, Pfeffenhausen (DE); Andreas Ott, Steinsberg (DE); Michael Schlogl, Budingen-Aulendiebach (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens VDO Automotive AG, Regensburg (DE)

(21) Appl. No.: 11/795,219

(22) PCT Filed: Dec. 12, 2005
(86) PCT No.: PCT/EP05/56665

§ 371 Date: Oct. 18, 2007

(30) Foreign Application Priority Data
Jan. 12, 2005 (DE) 10 2005 001 493.3

(51) Int. Cl. G05B 23/02

(52) U.S. Cl. 340/3.9

(57) ABSTRACT

The invention relates to a device and a method for controlling at least one air conducting element (15) in a motor vehicle. Said device comprises a first gas sensor (51) and a second gas sensor (52) which generate signals in accordance with the harmful gas concentration in the ambient air. An output signal that is used for triggering the air conducting element is generated with the aid of a signal evaluation unit. The aim of the invention is to create a method and a device which are used for controlling an air conducting element, accurately detect and distinguish the different development of harmful gas concentrations in the atmosphere and trigger the air conducting elements accordingly, and are embodied in an inexpensive, reliable, and durable manner. Said aim is achieved by configuring an electronic decision unit (4) that determines which of the two sensor signals is fed to a single signal evaluation unit during the current interval.

Devices for controlling air guiding elements in motor vehicles and methods for that purpose are known from the prior art. DE 29 41 305 A1 discloses, for example, an electrical device and a method for controlling the air conditioning system of a motor vehicle. In said device, a switch-over flap is arranged in such a way that optionally air can be directed into the passenger compartment through an air duct from inside the passenger compartment or air can be directed into the air duct from outside the vehicle. The supply of external air here is controlled as a function of the quality both of the external air and of the internal air of the vehicle. This system is controlled by gas sensors which measure the concentration of noxious gases in the external air and then switch the flaps to the recirculation position if the external air which contains pollutants is not to be allowed to enter the passenger compartment of the vehicle. If, on the other hand, a low concentration of noxious substances is measured in the external air by the gas sensors, the air guiding element is adjusted to the fresh air position which allows fresh external air to enter the passenger compartment of the vehicle. The two gas sensors can be embodied, for example, as carbon monoxide sensors and nitrogen oxide sensors. In this context it is appropriate for the air guiding element to be switched to the air recirculating position not only when both gas sensors indicate a high concentration of noxious gases but also if just one gas sensor signals a high concentration of noxious gases. It will generally even be the case that one noxious gas has a predominately high concentration while the other noxious gas is present in a less appreciable concentration.

The signals which are generated by the various noxious gas sensors are usually of different types. For example, a gas sensor for detecting carbon monoxide therefore has a different rated resistance than a sensor for detecting nitrogen oxide. Furthermore, the different gas sensors have different ageing phenomena and are generally very different in their tolerances. This results in the problem that it is set once a limiting value at which the switching over into the air recirculating position is triggered is extremely difficult if one of the gas sensors detects a concentration of noxious gases which is above this limiting value.

Furthermore, the concentrations of noxious gases in the external air change in very different ways in road traffic. The transition from a rural region into a built up area is such that the concentration of noxious gases will rise over a long distance traveled, and thus rise slowly and continuously over a relatively long period of time. In contrast, for example when traveling into a tunnel a sudden rise in the concentrations of noxious gases is to be expected. These different situations have to be sufficiently detected by the device for controlling the air guiding element and the specified method for controlling the air guiding element must be able to differentiate the various situations.

The object of the present invention is to specify a method and a device for controlling an air guiding element which reliably detect and differentiate the different trends for concentrations of noxious gas in the external air and which control the air guiding elements accordingly, but at the same time have a design which is cost effective and reliable and has a long service life.

The object is achieved according to the invention by means of the features of the independent patent claims.

In one embodiment of the invention, a first signal preprocessing element is arranged between the first gas sensor and the electronic decision unit, and a second signal preprocessing element is arranged between the second gas sensor and the electronic decision unit. Such signal preprocessing elements, which are generally constructed in the spatial vicinity of the sensor, sense the raw signals of the sensor and convert them into signals which can be transmitted and processed satisfactorily. When there are a plurality of possible electronic interference sources in the motor vehicle it is advantageous to subject the gas sensor signals as quickly as possible to first preprocessing so that the interference signals cannot assume an appreciable influence on the sensor signals.

In one development, the first signal preprocessing element has a first electronic differentiation element, and the second signal preprocessing element has a second electronic differentiation element. The change in the sensor signals over time includes important information about the profile of the concentration of pollutants in the ambient air, and this information can be made directly available by the electronic differentiation element and can be used for further signal processing.

In a further development the first signal preprocessing element has a first preamplifier, and the second signal preprocessing element has a second preamplifier. The preamplifiers amplify the raw signals from the sensors as soon as possible after they are produced, as a result of which electronic interferences from usually electromagnetically input extraneous sources cannot significantly falsify the sensor signals.

The invention permits numerous embodiments. Some of them will be explained by way of example with reference to the following figures, of which:

FIG. 1 shows a device for controlling a ventilation element,

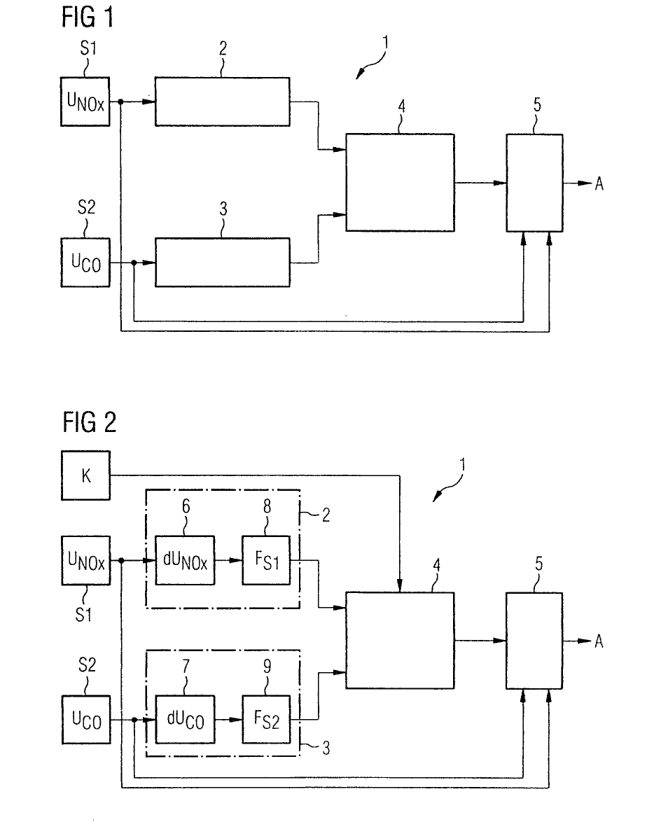

FIG. 2 shows a refinement of the design known from FIG. 1,

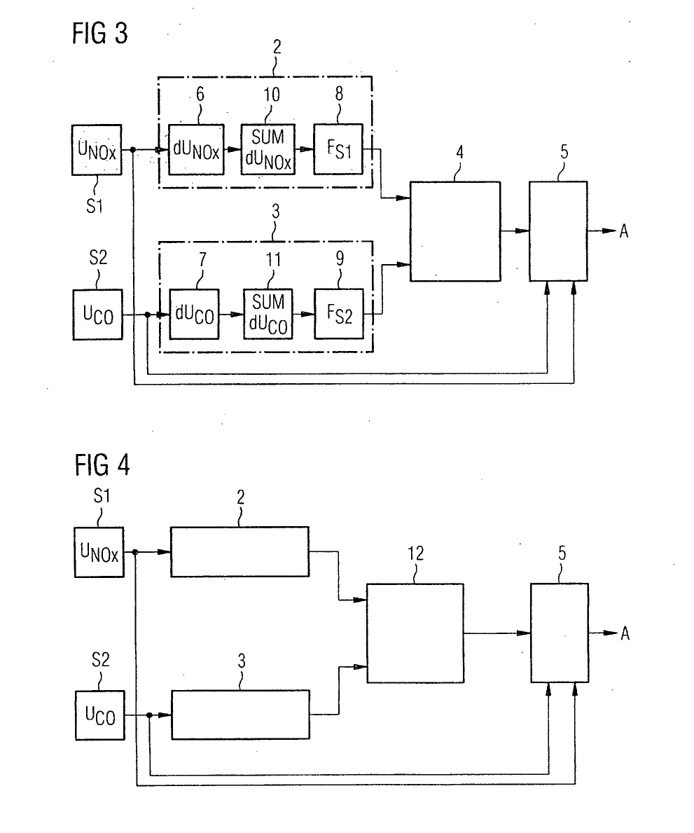

FIG. 3 shows a further refinement of the design known from FIG. 1,

FIG. 4 shows a subsequent embodiment of the device for controlling a ventilation element,

FIG. 5 shows a refinement of the design known from FIG. 4,

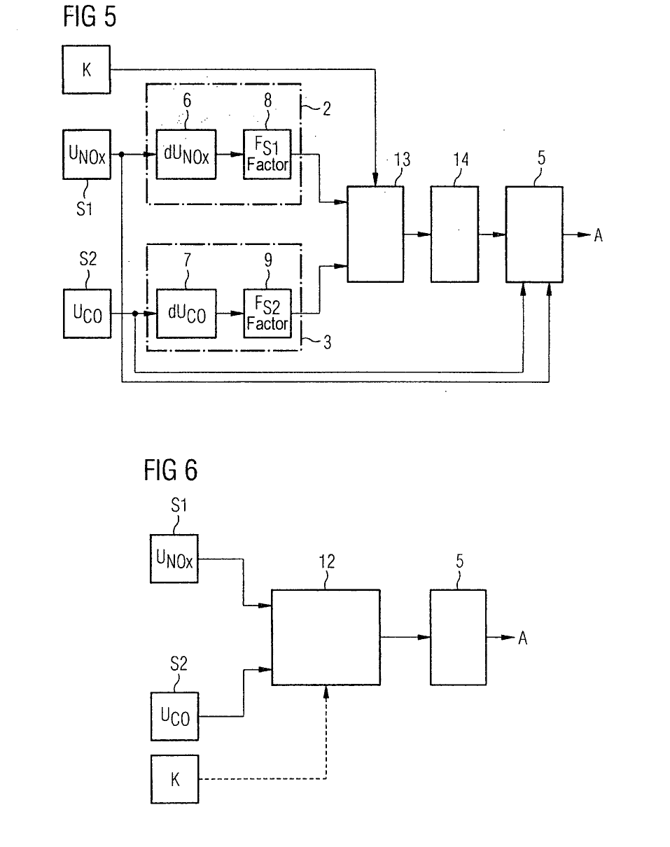

FIG. 6 shows a very simple embodiment of the invention,

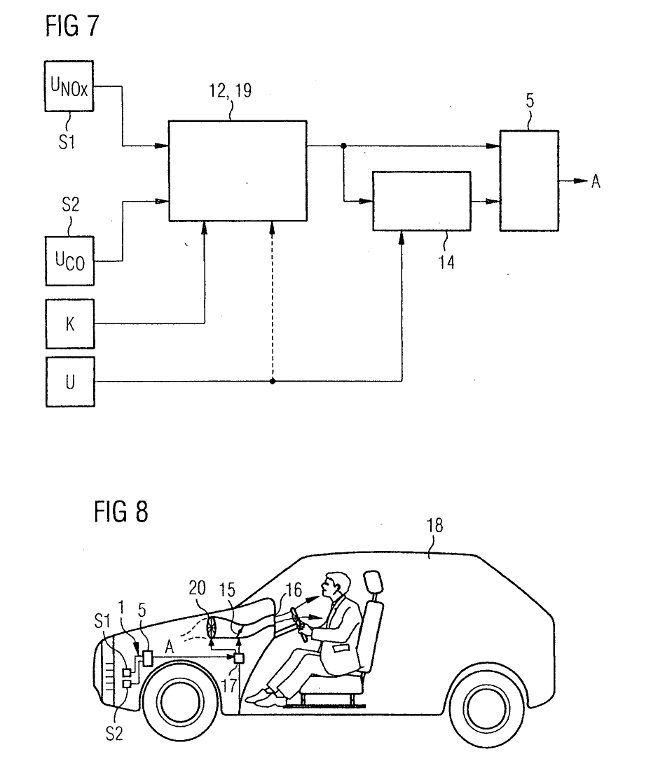

FIG. 7 shows a further embodiment of the invention, and

FIG. 8 shows an arrangement of the device for controlling an air guiding element in a motor vehicle.

FIG. 1 shows a device 1 for controlling a ventilation element, which device is used in a motor vehicle 18. This device 1 for controlling a ventilation element comprises a first gas sensor S1 and a second gas sensor S2. The first gas sensor S1 generates, for example, a signal UNOx which is proportional to the concentration of nitrogen oxides in the ambient air. The second gas sensor S2 generates, for example, a signal UCO which is proportional to the concentration of carbon monoxides in the ambient air. The first gas sensor S1 feeds the signal UNOx to a first signal preprocessing element 2, and the second sensor S2 feeds the signal UCO to a second signal preprocessing element 3. After the preprocessing of the signals UNOx, UCO, they are fed to the electronic decision unit 4. This electronic decision unit 4 selects one of the two sensor signals UNOx, UCO for a specific period of time and feeds just one single sensor signal UNOx or UCO to a single signal evaluation unit 5.

The device 1 which is described above for controlling a ventilation device has the advantage that the generally highly complex signal evaluation unit 5 is required just a single time, said signal evaluation unit 5 processing either the signal UNOx of the first gas sensor S1 or the signal UCO of the second gas sensor S2 depending on requirements. This significantly reduces the amount of electronics necessary to control a ventilation device, as a result of which the device for controlling a ventilation element can be manufactured significantly more cost-effectively. The signal evaluation unit 5 then supplies the output signal A with which the ventilation device can be actuated.

FIG. 2 shows the design which is known from FIG. 1 and which has a first gas sensor S1 and a second gas sensor S2. The gas sensors S1, S2 generate the signals UNOx and UCO and feed them to the first signal preprocessing element 2 and the second signal preprocessing element 3. The first signal preprocessing element 2 contains a first differentiation element 6 which forms the derivative dUNOx over time of the signal UNOx of the first gas sensor S1. This derived signal is fed to the first preamplifier 8, which is also integrated in the first signal preprocessing element 2. The first preamplifier 8 multiplies the derived signal dUNOx by the factor FS1. A comparable signal preprocessing operation is carried out for the signal UCO of the second gas sensor S2. The signal UCO is assigned to the second differentiation element 7 which is arranged in the second signal preprocessing element 3. Here, the derivative dUCO of the signal UCO over time is formed. The factor FS2 is also applied to this derivative dUCO within the second signal preprocessing element 3 in the second preamplifier 9.

The two signals UNOx and UCO from the first gas sensor S1 and the second gas sensor S2 then exit the first signal preprocessing element 2 and the second signal preprocessing element 3 after the signal preprocessing operation and are fed to the electronic decision unit 4. Furthermore, a signal K with information about the current position of the flaps can be fed to the electronic decision unit 4. The electronic decision unit 4 then selects either the preprocessed signal of the first gas sensor S1 or the preprocessed signal of the second gas sensor S2 and passes on one of the two signals to the single signal evaluation unit 5.

FIG. 3 illustrates in more detail a refinement of the first signal preprocessing element 2 and of the second signal preprocessing element 3. The signal UNOx which is generated by the first gas sensor S1 is subjected to derivation over time within the first signal preprocessing element 2 in the first differentiation element 6, after which the signals dUNOx from the first differentiation element 6 which have been subjected to derivation over time are summed in the first summing element 10, and the summed signal is multiplied by a factor FS1 in the first preamplifier 8. Analogously to this, the signal UCO of the second gas sensor S2 is firstly derived over time in the second differentiation element 7 within the second signal preprocessing element 3, with the signal dUCO being produced and being fed to the second summing element 11, with the sum of the derived signals dUCO being formed and after this a factor FS2 being applied to the signal in the second preamplifier 9. The signals from the gas sensors S1, S2 which are preprocessed in this way are fed to the electronic decision unit 4 which selects a single signal in a predefined time interval and feeds it to the single signal evaluation unit 5. The latter processes the applied signal and generates an output signal A which is used to control an air guiding element 15.

FIG. 4 shows an embodiment of the device 1 for controlling at least one air guiding element which is embodied in turn with at least two gas sensors S1 and S2 which feed their signals to a first signal preprocessing element 2 and to a second signal preprocessing element 3. After the preprocessing of signals, the signals are fed to an element 12 for mathematical logical combination of signals and which logically combines the preprocessed signals of the first sensor S1 and of the second sensor S2 by means of any desired mathematical operation. The signal which is generated in this way is then fed to a single evaluation unit 5. This mathematical operation can be, for example, summing of the two signals, formation of differences between the signals or multiplication of the signals. Furthermore, any desired complex function F(UNOx, UCO) can be formed with the element 12 for the mathematical logical combination of signals and be fed to the single signal evaluation unit 5. This function F(UNOx, UCO) can form any desired mathematical mapping from the definition range of the signals UNOx, UCO from the two gas sensors S1, S2 into the value range of the function F.

FIG. 5 illustrates once more in detail the first signal preprocessing element 2 and the second signal preprocessing element 3. The signal preprocessing elements 2 and 3 each contain a differentiation element 6, 7 and a preamplifier 8, 9. After the signals have exited the signal preprocessing element 2, 3, they are mathematically logically combined with one another in the element 12 for mathematically logically combining signals, said element 12 being embodied as an adding element 13. In addition, the element 12 for mathematically logically combining signals contains an element 14 for forming reference values. In the element 14 for forming reference values, a value which corresponds to the sum of the signals is formed from the sum of the sensor signals which is formed in the adding element 13. This signal is fed to the signal evaluation unit 5 which in turn produces an output signal A which permits at least one air guiding element to be controlled. In addition to the signals of the sensors F1, F2, a signal K for setting the flaps is made available to the adding element 13, which signal K can also be processed at the same time. It is therefore possible to form a mathematical function F(UNOx, UCO, K) which is dependent on the sensor signals UNOx, UCO and the flap position signal K.

FIG. 6 shows a very simple embodiment of the invention. Here, the preprocessing of the signals UNOX, UCO of the gas sensors S1, S2 is completely dispensed with and the sensor signals UNOx, UCO are fed directly to the element 12 for mathematically logically combining signals. The element 12 for mathematically logically combining signals produces any desired mathematical function F(UNOx, UCO, K) from the signals of the gas sensors S1, S2 and the flap position signal K and passes on the result to the single signal evaluation unit 5 which in turn generates an evaluation signal A which can be used to control at least one air guiding element 15.

In FIG. 7, the signals UNOx, UCO of the gas sensors S1 and S2 are also fed directly to the element 12 for mathematically logically combining signals, said element 12 being embodied here as a subtracting element 19. Furthermore, the element 12 for mathematically logically combining signals receives the flap position signal K. The element 12 for mathematically logically combining signals is capable of forming any desired mathematical function F(UNOx, UCO, K), which is then directly made available to the single signal evaluation unit 5 and/or can be further processed in the element 14 for forming reference values. In the element 14 for forming reference values it is also possible to use the signal from the element 12 for mathematically logically combining signals and a signal relating to further environmental parameters U to form a function which is made available to the signal evaluation unit. It is also conceivable for the further environmental parameters U to be fed to the element 12 for mathematically logically combining signals, as a result of which any desired mathematical function F(UNOx, UCO, K, U) can be formed here. The single signal evaluation unit 5 generates, from these signals, an output signal A which is used to control at least one air guiding element 15. Environmental parameters U in this context can be, for example, the external temperature, the humidity of the air or the formation of precipitation on the windows of the vehicle.

The advantage of the device (shown in FIGS. 1 to 7) for controlling at least one air guiding element 15 is the combination of the signals UNOx, UCO from the two gas sensors S1 and S2 and the evaluation of signals in a single signal evaluation unit 5. The single signal evaluation unit 5 significantly reduces the expenditure on electronic circuitry. The complex and expensive signal evaluation unit 5 is used more efficiently and the device for controlling at least one air guiding element can thus be constructed significantly more cost-effectively.

FIG. 8 shows a motor vehicle 18 in which the device 1 for controlling at least one air guiding element 15 is arranged. The gas sensors S1 and S2 which are assigned to the device 1 for controlling at least one air guiding element 15 are located in the front region of the motor vehicle 18. The signal evaluation unit 5 generates an output signal A which is fed to an air conditioning control unit 17 which actuates the air guiding element 15 while taking into account other parameters (for example the requirements of the vehicle occupants). The fan 20 feeds fresh air from the external region of the motor vehicle 18 into the internal region, and when the air guiding element 15 is opened the fresh air flows into the passenger compartment of the motor vehicle 18 via the air nozzles. If a high degree of loading with noxious gases is detected by the sensors S1 and S2, the air guiding element 15 is moved into a position in which the air is circulated only in the motor vehicle cell. This operating position of the air guiding element 15 is generally referred to as a recirculation mode.

1-23. (canceled)

24. A device for controlling an air guiding element of a motor vehicle, comprising:
a first gas sensor generating a first electrical signal as a function of a concentration of a first noxious gas in ambient air;
a second gas sensor generating a second electrical signal as a function of a concentration of a second noxious gas in the ambient air;
a signal evaluation unit; and
an electronic decision unit connected for receiving said first and second electrical signals and selecting one of said first and second electrical signals to be passed onto said signal evaluation unit, wherein said signal evaluation unit generates an output signal used to actuate the air guiding element based on the selected one of said first and second gas sensors.

25. The device of claim 24, further comprising a first signal preprocessing element connected between said first gas sensor and said electronic decision unit, and a second signal preprocessing element arranged between said second gas sensor and said electronic decision unit.

26. The device of claim 25, wherein said first signal preprocessing element includes a first electronic differentiation element, and said second signal preprocessing element includes a second electronic differentiation element.

27. The device of claim 26, wherein said first signal preprocessing element includes a first preamplifier and said second signal preprocessing element includes a second preamplifier.

28. The device of claim 27, wherein said first signal preprocessing element includes a first electronic summing means, and said second signal preprocessing element includes a second electronic summing means.

29. The device of claim 25, wherein said first signal preprocessing element includes a first preamplifier and said second signal preprocessing element includes a second preamplifier.

30. The device of claim 25, wherein said first signal preprocessing element includes a first electronic summing means, and said second signal preprocessing element includes a second electronic summing means.

31. The device of claim 24, wherein at least one further signal with information about current environmental parameters is fed to said device.

32. A device for controlling an air guiding element of a motor vehicle, comprising:
a first gas sensor generating a first electrical signal as a function of a concentration of a first noxious gas in ambient air;
a second gas sensor generating a second electrical signal as a function of a concentration of a second noxious gas in the ambient air;
a signal evaluation unit; and
an electronic element connected for receiving said first and second electrical signals and generates a result by logically combining said first and second electrical signals according to a mathematical operation, wherein said signal evaluation unit generates an output signal used to actuate the air guiding element based on the result of the mathematical operation.

33. The device of claim 32, further comprising a first signal preprocessing element arranged between said first gas sensor and said electronic element, and a second signal preprocessing element arranged between said second gas sensor and said electronic element.

34. The device of claim 33, wherein said first signal preprocessing element includes a first electronic differentiation element, and said second signal preprocessing element includes a second electronic differentiation element.

35. The device of claim 34, wherein said first signal preprocessing element includes a first preamplifier, and said second signal preprocessing element includes a second preamplifier.

36. The device of claim 33, wherein said first signal preprocessing element includes a first preamplifier, and said second signal preprocessing element includes a second preamplifier.

37. The device of claim 33, wherein said first signal preprocessing element includes a first electronic summing means, and said second signal preprocessing element includes a second electronic summing means.

38. The device of claim 32, wherein said electronic element is an adding element.

39. The device of claim 32, wherein said electronic element is a subtracting element.

40. The device of claim 32, wherein at least one further signal with information about current environmental parameters is fed to said device.

41. A method for controlling an air guiding element of a motor vehicle, comprising the steps of:
generating a first electrical signal by a first gas sensor as a function of a concentration of a first noxious gas in ambient air;
generating a second electrical signal by a second gas sensor as a function of a concentration of a second noxious gas in the ambient air; and
determining by an electronic decision unit which of the first and second electrical signals is to be fed to a signal evaluation unit in the current time interval.

42. The method of claim 41, further comprising the steps of feeding the first electrical signal of the first gas sensor to a first signal preprocessing element before the first electrical signal is sent to the electronic decision unit, and feeding the second electrical signal of the second gas sensor to a second signal preprocessing element before the second electrical signal is sent to the electronic decision unit.

43. The method of claim 41, wherein the first and second electrical signals are respectively differentiated in the first and second signal preprocessing elements.

44. The method of claim 41, wherein the first and second electrical signals are respectively amplified in the first and second signal preprocessing elements.

45. The method of claim 41, wherein the first and second electrical signals are respectively summed in the first and second signal preprocessing elements.

46. A method for controlling an air guiding element of a motor vehicle, comprising the steps of:
generating a first electrical signal by a first gas sensor as a function of a concentration of a first noxious gas in ambient air;
generating a second electrical signal by a second gas sensor as a function of a concentration of a second noxious gas in the ambient air;
logically combining the first and second electrical signals in accordance with a mathematical operation to generate a result by an electronic element; and
feeding the result to a signal evaluation unit.

47. The method of claim 46, further comprising the steps of feeding the first electrical signal of the first gas sensor to a first signal preprocessing element before the first electrical signal is sent to the electronic element, and feeding the second electrical signal of the second gas sensor to a second signal preprocessing element before the second electrical signal is sent to the electronic element.

48. The method of claim 47, wherein the first and second electrical signals are respectively differentiated in the first and second signal preprocessing elements.

49. The method of claim 47, wherein the first and second electrical signals are respectively amplified in the first and second signal preprocessing elements.

50. The method of claim 47, wherein the first and second electrical signals are respectively summed in the first and second signal preprocessing elements.
